(19) United States
(12) Patent Application Publication
(10) Pub. No.: US 2002/0120468 A1
(43) Pub. Date: Aug. 29, 2002

(54) Method and apparatus for providing financial analyses for medical procedures

(76) Inventor: William Atallah, Brooklyn, NY (US)

Correspondence Address: OSTROLENK FABER GERB & SOFFEN, 1180 AVENUE OF THE AMERICAS, NEW YORK, NY, 100368403

(21) Appl. No.: 09/999,333

(22) Filed: Nov. 30, 2001

Related U.S. Application Data
(60) Provisional application No. 60/253,334, filed on Nov. 27, 2000.

(51) Int. Cl. G06F 17/60

(52) U.S. Cl. 705/2

(57) ABSTRACT

A method for providing a financial analysis for a medical procedure comprising: entering into a computer system at least one datum identifying the medical procedure; entering into the computer system all identifiable costs associated with the medical procedure, entering into the computer system all identifiable insurance payments and payments from other sources associated with the medical procedure, and using the computer system to determine a profit or loss based on the entered costs and payments associated with the medical procedure.

### CROSS REFERENCE TO RELATED APPLICATIONS

This application claims the benefit and priority of U.S. provisional patent application No. 60/253,334 filed Nov. 27, 2000 and entitled “Method and Apparatus for Providing Financial Analyses for Medical Procedures”, the entire disclosure of which is hereby incorporated by reference herein.

### BACKGROUND OF THE INVENTION

The present invention relates to methods and apparatus for providing financial analyses for medical procedures.

At the present time, to the applicant's knowledge, there is no existing program or software for determining whether a medical procedure is profitable for a healthcare provider. For example, many hospitals receive fixed insurance payments from healthcare insurers for procedures that they perform. It is known that often, the healthcare provider loses money on these procedures because the cost of the procedure exceeds the insurance payment received from the healthcare insurer.

The applicant is aware of the following patents:

| Patent No. | Inventor | Dated |
|---|---|---|
| 5,732,401 | Conway | Mar. 24, 1998 |
| 5,918,208 | Javitt | June 29, 1999 |
| 6,014,632 | Gamble et al. | Jan. 11, 2000 |
| 6,088,677 | Spurgeon | July 11, 2000 |
| 5,748,907 | Crane | May 5, 1998 |
| 5,550,734 | Tarter et al. | Aug. 27, 1996 |
| 5,6521,842 | Siegrist, Jr. et al. | July. 29, 1997 |
| 5,705,044 | Tarter et al. | Dec. 30, 1997 |
| 5,819,228 | Spiro | Oct. 6, 1998 |
| 5,890,129 | Spurgeon | March 30, 1999 |
| 5,956,690 | Haggerson et al. | Sept. 21, 1999 |
| 6,014,633 | DeBusk et al. | Jan. 11, 2000 |
| 6,052,672 | Foster | April 18, 2000 |
| 6,067,522 | Warady et al. | May 23, 2000 |
| 6,070,177 | Kao et al. | May 30, 2000 |
| 6,073,108 | Peterson | June 6, 2000 |

### SUMMARY OF THE INVENTION

An object of the present invention is to provide a system, preferably real time, whereby healthcare costs associated with medical procedures can be entered into a computer and a program stored therein will conduct an analysis on the entered data to determine whether the procedure is profitable for the healthcare provider. The program accepts various detailed inputs for the procedures and the costs associated with the procedures. The program will also accept the amount of the insurance payment or payments provided for the procedures. Often the insurer will provide a single lump sum payment covering all the costs involved with a procedure or procedures. The program will then calculate the profit or loss on the medical procedure or procedures and preferably provide an analysis of the profit or loss.

Other features and advantages of the present invention will become apparent from the following description of the invention which refers to the accompanying drawings.

### BRIEF DESCRIPTION OF THE DRAWINGS

The invention will be described in detail in the following detailed description with reference to the drawings, in which:

FIG. 1 shows a flow chart illustrating an exemplary embodiment of the invention; and

FIG. 2 shows an exemplary output of the invention.

### DETAILED DESCRIPTION

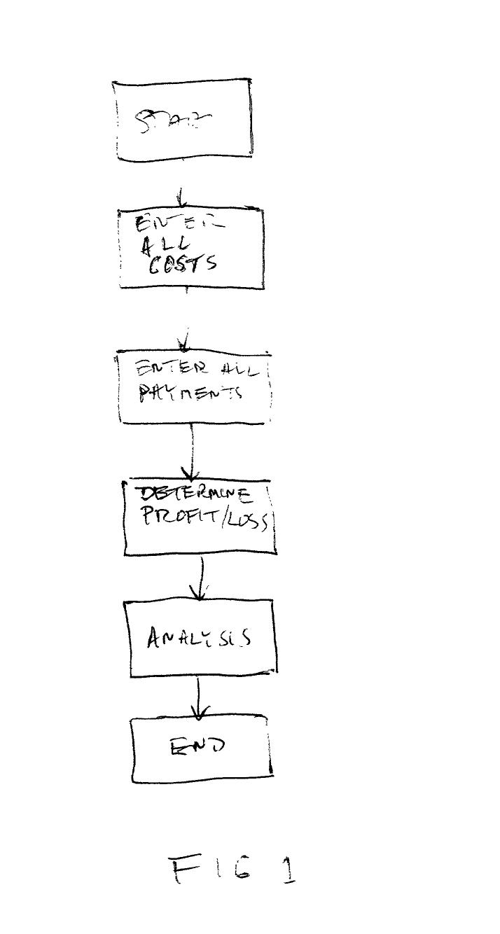

FIG. 1 shows an exemplary embodiment of the invention. The healthcare provider enter all the costs, and all the payments provided by the insurer. This can be done at the time of performing the procedure or at a later time. The program returns a calculation of the profit or loss. An analysis may be performed of the profit or loss in an effort to attempt to identify, particularly in the case of a loss, ways to save costs or to make the procedure more efficient so that the loss is reduced or the loss converted to a profit. If a loss is calculated, the results of the program can be provided to insurers to persuade the insurer to increase the payments to reasonable levels.

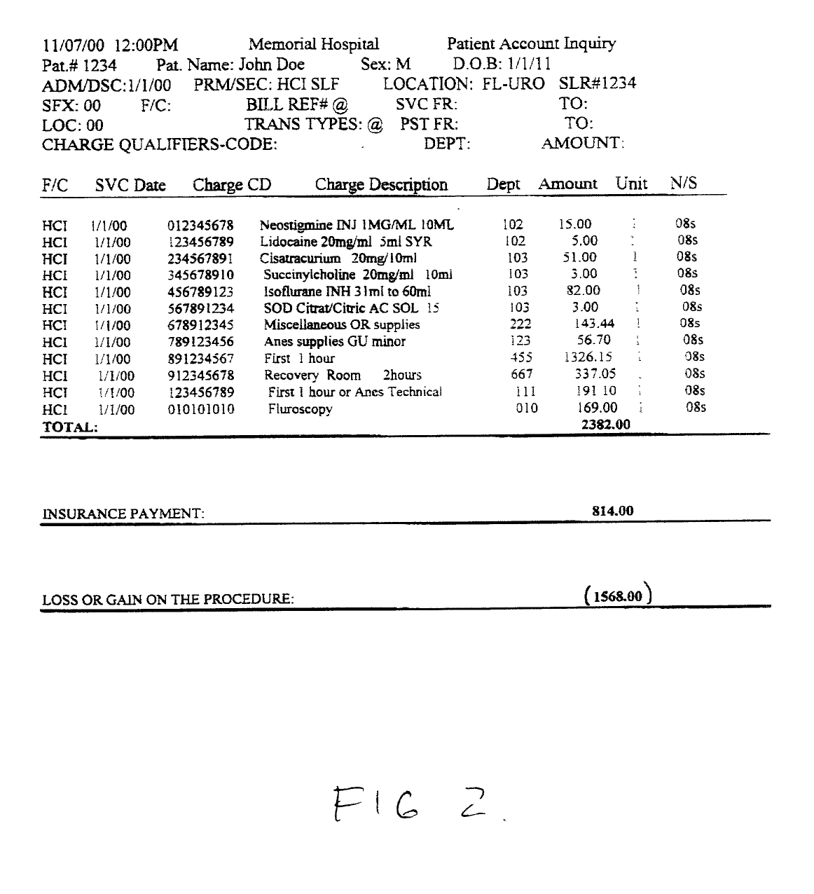

FIG. 2 shows an example of an output of the program. At the top of FIG. 2, information is provided concerning the date of the procedure, the healthcare provider, the patient and various other information concerning the procedure and the location where the procedure was performed.

An itemized listing is then provided of the various items required in performing the procedure. All costs associated with the procedure or procedures including time spent, medications utilized, equipment utilized, etc. are included in the listing and a total is calculated. The aim here is to calculate the costs associated with the procedure for the hospital or other health care provider, not the attending physician's fees and/or costs. Alternatively, it is also possible to include the costs and fees of the attending physician or physicians although the example shown only shows various costs associated with the procedure not including the fees and costs associated with the medical professionals attending. Typically, this is because the attending physicians are reimbursed separately by the health care insurer.

All insurance payments are entered, in this example, a single lump sum insurance payment has been entered for the particular procedure which includes the various costs indicated. As shown, in the exemplary example, the total costs to the healthcare provider were $2,382.00. The insurance payment was $814.00, resulting in a loss of $1,568.00. This output can be provided to the insurer in an effort to convince the insurer to increase the payment to more reasonable levels. Further, the detailed profit/loss determination shown could be used to perform a further analysis as shown in FIG. 1, in an effort to reduce costs and/or increase efficiencies.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A method for providing a financial analysis for a medical procedure comprising:
entering into a computer system at least one datum identifying the medical procedure;
entering into the computer system all identifiable costs associated with the medical procedure;
entering into the computer system all identifiable insurance payments and payments from other sources associated with the medical procedure; and
using the computer system to determine a profit or loss based on the entered costs and payments associated with the medical procedure.

2. The method of claim 1, further comprising performing an analysis on the profit or loss to make the medical procedure more efficient.

3. The method of claim 1, further comprising presenting, in the case of a computed loss, the computed loss to an insurer to attempt to persuade the insurer to increase an insurance payment for the medical procedure.

4. The method of claim 1, wherein the at least one datum includes at least one of a date of the medical procedure, a health care provider and a patient identification.

5. The method of claim 1, wherein the identifiable costs entered into the computer system include time spent, medications utilized and equipment utilized.
